(19) United States
(12) Patent Application Publication
(10) Pub. No.: US 2008/0197986 A1
(43) Pub. Date: Aug. 21, 2008

(54) Method of securing car against theft by incorporating antitheft status LED in remote controller

(76) Inventor: Tse Hsing Chen, Chung-Ho City (TW)

Correspondence Address: BACON & THOMAS, PLLC, 625 SLATERS LANE, FOURTH FLOOR, ALEXANDRIA, VA, 22314, US

(21) Appl. No.: 11/706,365

(22) Filed: Feb. 15, 2007

(51) Int. Cl. B60R 25/10

(52) U.S. Cl. 340/426.15; 340/426.14; 340/430

(57) ABSTRACT

In a method of securing car against theft, a status LED light set is incorporated in a remote controller for an antitheft main unit mounted on the car. The method includes the step of providing the remote controller with a CPU circuit; a transmission circuit for transmitting codes to remotely actuate or release an actuated status of the antitheft main unit; a button set for setting a security code for actuating the antitheft status and inputting a PIN (personal identification number) code for releasing the antitheft status; a status LED light set for indicating an actual status of the antitheft main unit; and a power supply circuit; so that the remote controller not only remotely controls the antitheft main unit, but also indicates the actual status of the antitheft main unit.

### FIELD OF THE INVENTION

The present invention relates to a method of securing car against theft, and more particularly to a method of securing car against theft by incorporating antitheft status LED lights in a remote controller, so that the remote controller not only remotely controls an antitheft main unit mounted on a car, but also indicates an actual status of the antitheft main unit via the status LED lights.

### BACKGROUND OF THE INVENTION

Currently, the simplest way of securing a car against theft is to mount a remotely controllable antitheft main unit in the engine room of the car and connect the antitheft main unit to positive and negative power sources. The antitheft main unit uses built-in vibration sensor and voltage drop circuit to detect any change in the voltage caused by vibration, opening of car doors, and ignition by turning an engine button, and thereby triggers an alarm.

Some of the remotely controllable antitheft main units are connected to a status LED light via wire, so that an actual antitheft status of the main units is indicated by the on or off of the status LED light. Sometimes, there are multiple status LED lights connected to the main unit to indicate different conditions, which provides improved securing effect and increases the sale.

However, it is difficult to install the status LED lights by the car owner because LED wires must be extended from the engine room to the interior of the car for connecting to the antitheft main unit and the LED lights. Moreover, a thief can easily locate the antitheft main unit by tracking the wire extended between the status LED lights and the main unit, and then destroys the antitheft main unit.

While it is possible to use wireless LED lights, the wireless receiving circuit and decoding circuit in the wireless LED lights would largely increase the cost of the security system, the current consumption, and the volume of the LED lights. Moreover, there is the problem of interference due to the same frequency used for the main unit and the LED lights. These factors have adversely affected the share of the antitheft system with wireless LED lights.

Currently, most newly manufactured cars are shipped along with a wireless remote controller for remotely controlling the door locks. When the car owners choose to mount on the car an additional security system, they tend to avoid the remotely controllable security system, so that they do not have to troublesomely carry two remote controllers separately for the door locks and the security system.

It is therefore tried by the inventor to develop a method of securing car against theft that enables a car owner to use only keyless entry remote controller to remotely control the car doors, and an antitheft main unit mounted in the car, and to confirm the actual status of the antitheft main unit via LED lights which build in the antitheft remote controller.

### SUMMARY OF THE INVENTION

A primary object of the present invention is to provide a method of securing car against theft by incorporating status LED in remote controller, so that the remote controller not only remotely controls an antitheft main unit mounted on a car, but also indicates the actual antitheft status of the antitheft main unit via LED lights.

To achieve the above and other objects, the method of securing car against theft according to the present invention includes the step of providing a remote controller for an antitheft main unit mounted on a car with a CPU circuit; a transmission circuit for transmitting codes to remotely actuate or release an actuated status of the antitheft main unit; a button set for setting a security code and inputting a PIN (personal identification number) code for releasing the antitheft status; a status LED light set for indicating an actual status of the antitheft main unit; and a power supply circuit for supplying power needed by the remote controller to operate normally.

The antitheft main unit is internally provided with a receiving circuit for receiving code and instruction transmitted from the transmission circuit of the remote controller, and can therefore be remotely controlled to actuate or release from an actuated state by the remote controller.

Since the remote controller used in the method of the present invention is a wireless remote controller and has status LED lights provided thereon to indicate the actual status of the antitheft main unit at any time, no wire is required between the main unit and the remote controller. Therefore, there is a wide choice of places on the car for mounting the antitheft main unit without the risk of being located by a thief.

With the method of the present invention, the remote controller may have reduced volume and include LED lights of different colors to provide an enhanced visual warning effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing a method of securing car against theft according to a preferred embodiment of the present invention;

FIG. 2 is a block diagram of a CPU circuit employed in a remote controller used to implement the method of the present invention;

FIG. 3 is a block diagram showing another embodiment of the present invention; and

FIG. 4 is a block diagram showing a further embodiment of the present invention.

### DETAILED DESCRIPTION OF THE. PREFERRED EMBODIMENTS

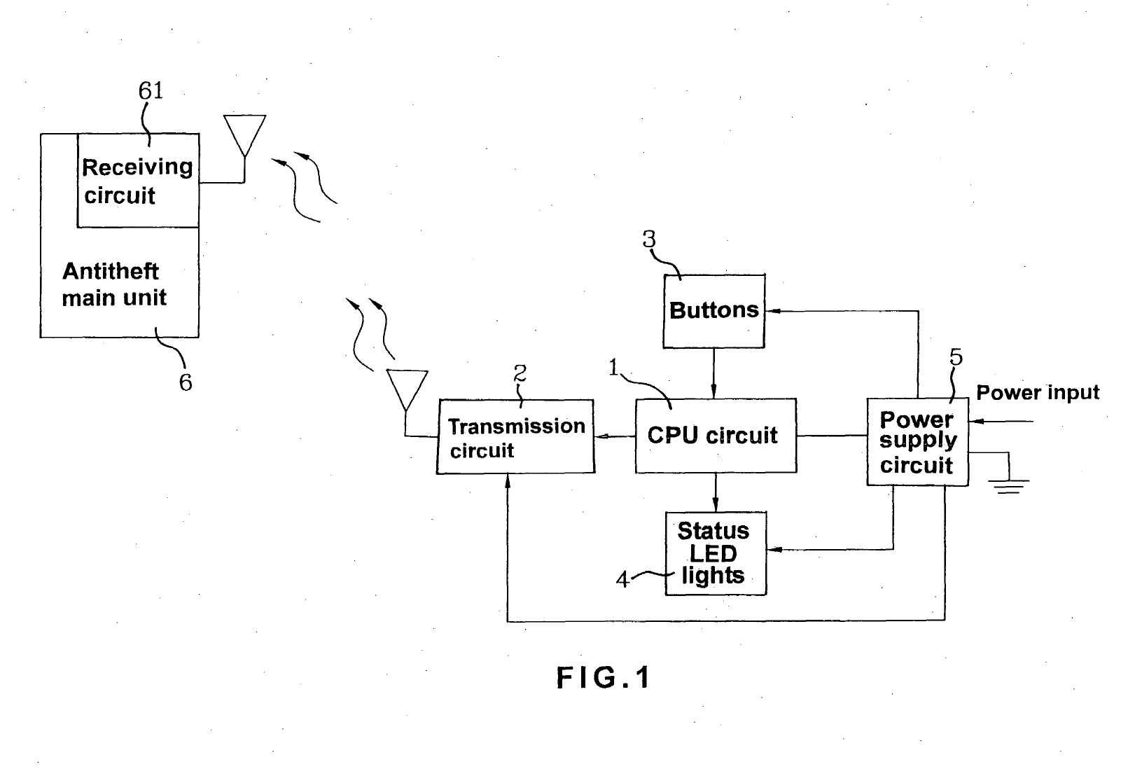

Please refer to FIG. 1 that is a block diagram showing a method of securing car against theft by incorporating antitheft status LED in remote controller according to a preferred embodiment of the present invention.

The method of the present invention for securing a car against theft includes the step of providing a CPU circuit 1, a transmitting circuit 2, a button set 3, a status LED light set 4, and a power supply circuit 5 in a wireless remote controller for an antitheft main unit 6 mounted on the car.

The CPU circuit 1 is electrically connected to the transmitting circuit 2, the button set 3, the status LED light set 4, and the power supply circuit 5.

The CPU circuit 1 functions to encode for transmission, control the status LED light set 4, and set and release setting of security codes via the button set 3.

The transmission circuit 2 functions to transmit a security code encoded by the CPU circuit 1 to remotely control the antitheft main unit 6 mounted on the car.

The button set 3 are used to set a security code and input a PIN code for releasing the car from an antitheft status.

The status LED light set 4 indicates whether the antitheft main unit 6 on the car has been activated or not.

The power supply circuit 5 supplies power required by all circuits in the remote controller to operate normally.

The antitheft main unit 6 is internally provided with a receiving circuit 61 for receiving the code and instruction transmitted from the transmission circuit 2 of the remote controller.

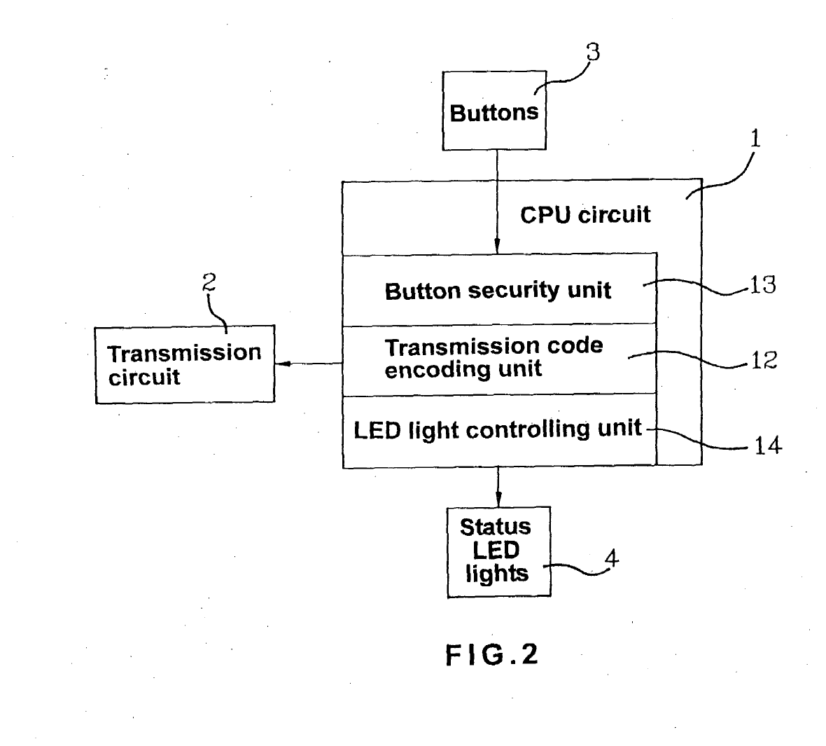

Please refer to FIG. 2 that is a block diagram of the CPU circuit 1 in the remote controller. As shown, the CPU circuit 1 includes a transmission code encoding unit 12 electrically connected to the transmission circuit 2, a button security unit 13 electrically connected to the button set 3, and an LED light controlling unit 14 electrically connected to the status LED light set 4.

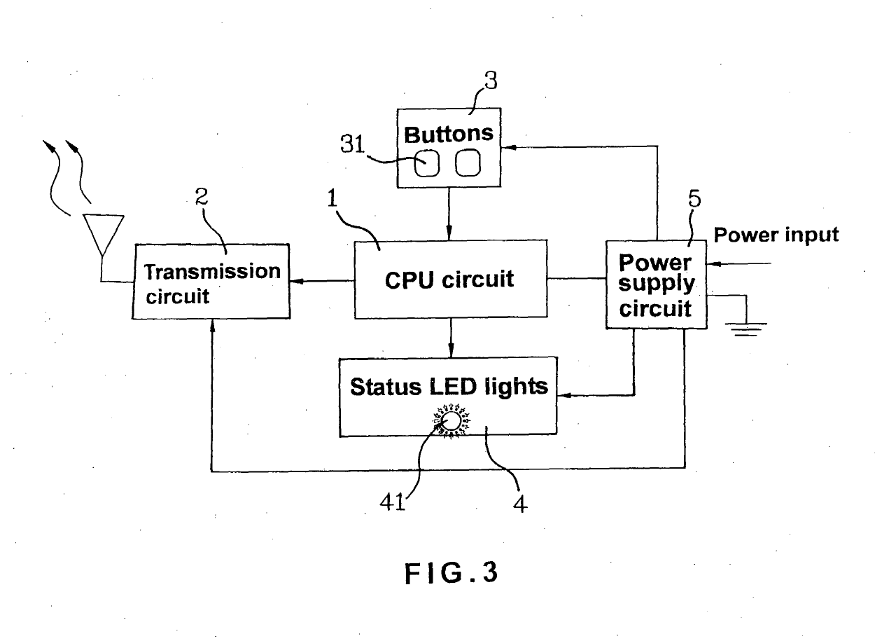

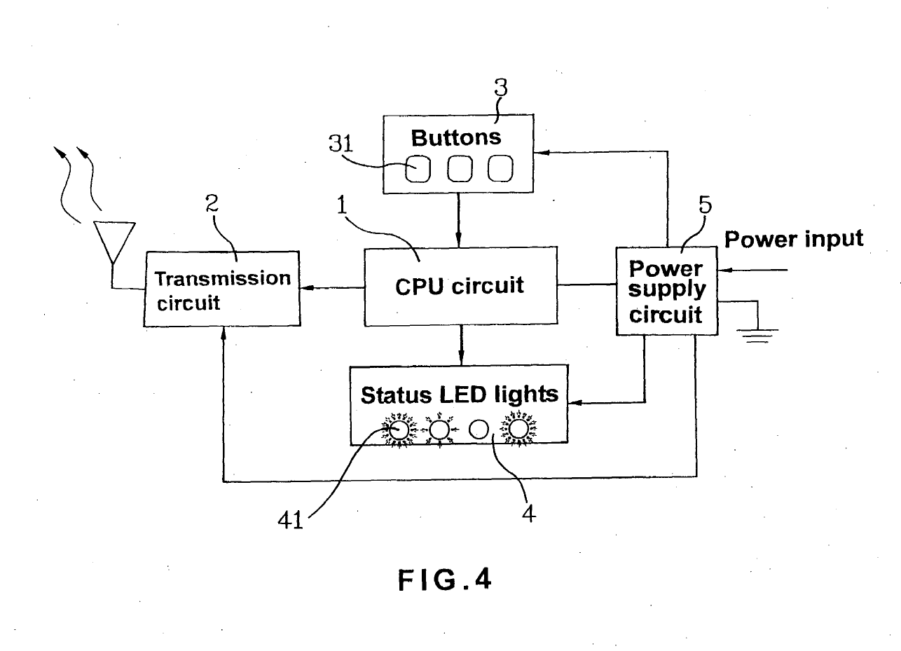

The status LED light set 4 may include more than one LED light 41, and the button set 3 may include two or more buttons 31. FIGS. 3 and 4 are block diagrams showing two embodiments of the present invention. In the embodiment shown in FIG. 3, there are two buttons 31 included in the button set 3, and one status LED light 41 included in the status LED light set 4. In the embodiment shown in FIG. 4, there are three buttons 31 included in the button set 3, and four status LED lights 41 included in the status LED light set 4.

When the wireless remote controller originally supplied along with the antitheft main unit 6 incorporates the CPU circuit 1, the status LED light set 4 may be additionally provided on the original wireless remote controller by connecting the status LED light set 4 to extra pins of the CPU circuit 1, and the button set 3 on the original wireless remote controller may be used to set a security code and input a PIN code for releasing the car from an antitheft status. In this manner, the wireless remote controller for the antitheft main unit 6 could be used not only to remotely control the actuation of the antitheft main unit 6 via the buttons 31, but also to indicate an actual status of the antitheft main unit 6 via differently flashing status LED lights 41. That is, the status LED lights 41 provided on the wireless remote controller of the car may be caused to flash differently to indicate whether the antitheft main unit 6 has been correctly set and actuated to secure the car against theft. What is more important is there is not any wire between the antitheft main unit 6 and the wireless remote controller to effectively prevent a thief from locating the antitheft main unit 6 in the car.

In practical implementing the method of the present invention, it is possible to designate a particular button 31 of the button set 3 for actuating the antitheft function. When the designated actuating button 31 is pushed, one or more lights 41 of the status LED light set 4 start flashing, so as to indicate the antitheft main unit 6 has been actuated. Moreover, it is possible to preset a fixed get-out time limit, and the antitheft main unit 6 immediately enters into an active warning state as soon as the preset get-out time limit lapsed.

To release the antitheft main unit 6 from the active warning state, it is possible to preset a fixed release time limit. When a user gets in the car while the antitheft main unit 6 is still in the actuated status, the user is allowed to input the correct PIN code using the buttons 31 within the preset release time limit to release the antitheft main unit 6 from the actuated status. It is also possible to preset a fixed re-input times limit to allow the user to input the PIN code again in case that the user should get in the car and input an incorrect PIN code.

In a simplified status indicating mode of the method of the present invention, only one status LED light 41 is provided on the remote controller. For example, when the only one status LED light 41 shines or flashes, it indicates the antitheft main unit 6 is in an actuated status, as shown in FIG. 3. Or, in a somewhat complicate status indicating mode of the method of the present invention, multiple status LED lights 41 are provided on the remote controller to shine or flash differently to provide an enhanced visual warning effect, as shown in FIG. 4.

The PIN code is set and input using the buttons 31. When there are two buttons 31 included in the button set 3, as shown in FIG. 3, the PIN code for releasing the security status may be encoded as 12112 or 1121 or other preferred codes. Or, when there are three buttons 31 included in the button set 3, as shown in FIG. 4, the PIN code for releasing the security status may be encoded as 1232 or 12332 or other preferred codes.

The following are some features of the present invention:
1. There is not any wire between the status LED lights 31 and the antitheft main unit 6, preventing a thief from finding out the antitheft main unit 6 by tracking LED wire. Therefore, there can be a wide choice of places on the car for safely mounting the antitheft main unit 6.
2. The status LED lights 31 consisting of a plurality of LED's may separately show a different color and flashing manner to enhance the visual warning effect of the LED light set 3, which advantageously improves the security effect and makes the antitheft product more attractive for sale.
3. The antitheft main unit 6 could be remotely actuated via the button set 3, and the status LED lights 31 start flashing in selected manners when the main unit 6 is actuated. Similarly, the antitheft main unit 6 could be remotely released from the actuated state by inputting a correct PIN code within a fixed releasing time limit using the buttons 31. Moreover, the PIN code may be changed in a preset manner.
4. The same method of the present invention could be used to instead of antitheft which does not have status LED. For some DIY (Do It Yourself) type of antitheft main units that do not include any LED light, so the present invention can be used to instead of the original remote controller with a remote controller with status LED lights according to the method of the present invention to indicate the actuating status of the DIY antitheft main unit. Again, there is not any wire between the DIY antitheft main unit and the status LED lights of the remote controller according to the present invention.
5. With the remote controller according to the present invention, a user needs not to carry an original remote controller for keyless entry of the car and an antitheft remote controller.
6. Since the remote controller incorporating status LED lights according to the present invention does not include any wireless receiving circuit, it is not necessary to constantly keep the remote controller in a powered condition. The remote controller consumes power only when the transmission circuit 2 in the remote controller is used to transmit a security code or a PIN code to remotely control the antitheft main unit 6. Therefore, the remote controller according to the present invention is power-saving and may have a reduced volume to facilitate the designing of differently shaped remote controllers.
7. The same one CPU circuit 1 is used to control encoding for transmission and the LED light. When the CPU circuit 1 has extra output pins, more than one LED light 41 may be provided on the remote controller and driven to flash in different manners to enhance the visual warning effect and attract more consumers.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of securing car against theft by incorporating antitheft status LED in remote controller, comprising the steps of utilizing extra pins on a CPU circuit of a wireless remote controller for an antitheft main unit mounted on a car to electrically connect to a status LED light set; and using buttons of a button set on said wireless remote controller to set a security code for remotely actuating said antitheft main unit on the car, and input a PIN code for remotely releasing said antitheft main unit from an actuated status; whereby there is not any wire between said antitheft main unit and said wireless remote controller, and said wireless remote controller may be used to remotely control the antitheft main unit via said button set and indicate an actual status of said antitheft main unit via LED lights at the same time.

2. The method of securing car against theft by incorporating antitheft status LED in remote controller as claimed in claim 1, further comprising the steps of specifying a particular button of said button set on said remote controller for actuating said antitheft main unit and causing said status LED lights to flash when said antitheft main unit is actuated; and presetting a fixed get-out time limit using said button set, so that said antitheft main unit immediately enters into the actuated status as soon as said fixed get-out time limit lapsed.

3. The method of securing car against theft by incorporating antitheft status LED in remote controller as claimed in claim 1, further comprising the step of presetting a fixed release time limit using said button set; whereby when a user gets in the car while said antitheft main unit is still in the actuated status, the user is allowed to input said PIN code using said button set within said fixed release time limit to release said antitheft main unit from the actuated status.

4. The method of securing car against theft by incorporating antitheft status LED in remote controller as claimed in claim 3, further comprising the step of presetting a fixed re-input times limit, within which the user is allowed to input said PIN code again in case that the user should get in the car and input an incorrect PIN code.
